(19) United States
(12) Patent Application Publication
(10) Pub. No.: US 2023/0118614 A1
(43) Pub. Date: Apr. 20, 2023

(54) ELECTRONIC DEVICE AND METHOD FOR TRAINING NEURAL NETWORK MODEL

(71) Applicant: Industrial Technology Research Institute, Hsinchu (TW)

(72) Inventors: Mao-Yu Huang, Yunlin County (TW); Sen-Chia Chang, Hsinchu City (TW); Ming-Yu Shih, Taoyuan City (TW); Tsann-Tay Tang, Taipei City (TW); Chih-Neng Liu, Tainan City (TW)

(73) Assignee: Industrial Technology Research Institute, Hsinchu (TW)

(21) Appl. No.: 17/534,340

(22) Filed: Nov. 23, 2021

(30) Foreign Application Priority Data
Oct. 20, 2021 (TW) 110138818

(51) Int. Cl. G06N 3/08; G06N 3/04

(52) U.S. Cl. CPC G06N 3/08; G06N 3/0472; G06N 3/0454

(57) ABSTRACT

An electronic device and a method for training a neural network model are provided. The method includes: obtaining a first neural network model and a first pseudo-labeled data; inputting the first pseudo-labeled data into the first neural network model to obtain a second pseudo-labeled data; determining whether a second pseudo-label corresponding to the second pseudo-labeled data matching a first pseudo-label corresponding to the first pseudo-labeled data; in response to the second pseudo-label matching the first pseudo-label, adding the second pseudo-labeled data to a pseudo-labeled dataset; and training the first neural network model according to the pseudo-labeled dataset.

### CROSS-REFERENCE TO RELATED APPLICATION

This application claims the priority benefit of Taiwan application serial no. 110138818, filed on Oct. 20, 2021. The entirety of the above-mentioned patent application is hereby incorporated by reference herein and made a part of this specification.

### TECHNICAL FIELD

This disclosure relates to an electronic device and a method adaptable for training neural network model.

### BACKGROUND

Most of the existing supervised machine learning is to manually generate labeled data, and then use the labeled data to train a machine learning model (for example, a deep learning model). In order to increase the accuracy of the machine learning model, it is often required to collect a large amount of labeled data. However, the method of manually generating labeled data not only consumes time and human resources, but also is likely to cause data to be erroneously labeled due to human error, leading to reduction of effectiveness of the machine learning model. In addition, in vertical applications (such as industrial vision, medicine, etc.), it is often difficult to collect recognized target images (such as flawed images, symptom images, etc.), which increases the difficulty of introducing machine learning. Therefore, how to reduce the amount of labeled data that needs to be manually generated without reducing the performance of the machine learning model is one of the important issues in this field.

### SUMMARY

The disclosure provides an electronic device and a method adaptable for training a neural network model, which can use a small amount of artificially labeled data to train a neural network model with high performance.

An electronic device adaptable for training a neural network model disclosed in the disclosure includes a storage medium and a processor. The storage medium stores a first neural network model. The processor is coupled to the storage medium, and the processor is configured to: obtain a first pseudo-labeled data; input the first pseudo-labeled data into the first neural network model to obtain a second pseudo-labeled data; determine whether a second pseudo-label corresponding to the second pseudo-labeled data matches a first pseudo-label corresponding to the first pseudo-labeled data; in response to that the second pseudo-label matches the first pseudo-label, add the second pseudo-labeled data to a pseudo-labeled dataset; and train the first neural network model according to the pseudo-labeled dataset.

A method for training a neural network model in the disclosure includes: obtaining a first neural network model and a first pseudo-labeled data; inputting the first pseudo-labeled data into the first neural network model to obtain a second pseudo-labeled data; determining whether a second pseudo-label corresponding to the second pseudo-labeled data matches a first pseudo-label corresponding to the first pseudo-labeled data; in response to that the second pseudo-label matches the first pseudo-label, adding the second pseudo-labeled data to a pseudo-labeled dataset; and training the first neural network model according to the pseudo-labeled dataset.

### BRIEF DESCRIPTION OF THE DRAWINGS

FIG. 1 is a schematic diagram of an electronic device adaptable for training a neural network model according to an embodiment of the disclosure.

FIG. 2 is a schematic diagram of the first stage of a semi-supervised learning architecture according to an embodiment of the disclosure.

FIG. 3 is a schematic diagram of the second stage of the semi-supervised learning architecture according to an embodiment of the disclosure.

FIG. 4 is a schematic diagram of an adaptive matching training method according to an embodiment of the disclosure.

FIG. 5 is a schematic diagram of a sub-neural network model according to an embodiment of the disclosure.

FIG. 6 is a schematic diagram of the third stage of the semi-supervised learning architecture according to an embodiment of the disclosure.

FIG. 7 is a schematic diagram of the test results of the present disclosure and the conventional active learning method according to an embodiment of the disclosure.

FIG. 8 is a flowchart of a method adaptable for training a neural network model according to an embodiment of the disclosure.

### DETAILED DESCRIPTION OF DISCLOSED EMBODIMENTS

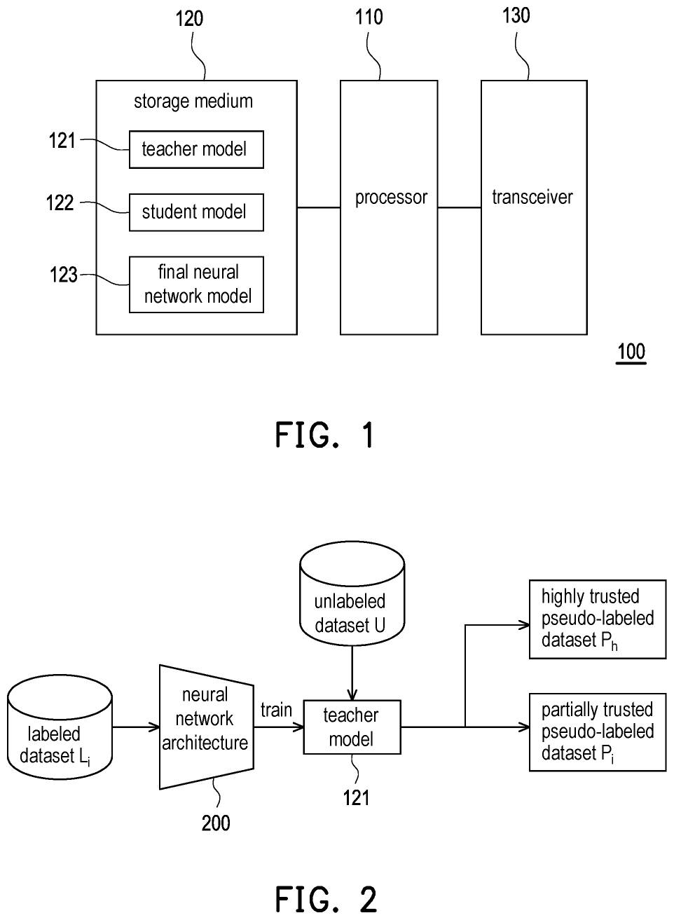

FIG. 1 is a schematic diagram of an electronic device 100 adaptable for training a neural network model according to an embodiment of the disclosure. The electronic device 100 may include a processor 110, a storage medium 120 and a transceiver 130.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA) or other similar components or a combination of the above components. The processor 110 may be coupled to the storage medium 120 and the transceiver 130, and access and execute multiple modules and various application programs stored in the storage medium 120.

The storage medium 120 is, for example, any type of fixed or removable random access memory (RAM), read-only memory (ROM), flash memory, hard disk (HDD), solid state drive (SSD) or similar components or a combination of the above components, and adapted to store multiple modules or various application programs that can be executed by the processor 110. In this embodiment, the storage medium 120 can store a teacher model (or referred to as “second neural network model”) 121, a student model (or referred to as “first neural network model”) 122, and a final neural network model 123, etc. The functions of multiple models will be explained later.

The transceiver 130 transmits and receives signals in a wireless or wired manner. The electronic device 100 can receive data or output data through the transceiver 130.

FIG. 2 is a schematic diagram of the first stage of a semi-supervised learning (SSL) architecture according to an embodiment of the disclosure. The first stage is adapted to generate initial pseudo-labeled data. First, the processor 110 may obtain an initial labeled dataset Lᵢ, and i is an index of the labeled dataset, and the labeled dataset Lᵢ may include one or more labeled data. For example, the processor 110 may generate the labeled dataset Lᵢ through an active learning algorithm. On the other hand, the labeled dataset Lᵢ can also be generated by people marking the data.

After obtaining the labeled dataset Lᵢ, the processor 110 may train the neural network architecture 200 based on the labeled dataset Lᵢ to obtain the teacher model 121, and the teacher model 121 may include, but is not limited to, a convolution neural network (CNN) model. The neural network architecture 200 may include information such as the type of neural network (for example, convolution neural network), the weight configuration method of the neural network, the loss function of the neural network, or the hyperparameters of the neural network, etc. The disclosure is not limited thereto. The processor 110 may train the neural network architecture 200 according to supervised learning (SL) to obtain the teacher model 121.

After completing the training of the teacher model 121, the processor 110 can input the unlabeled dataset U to the teacher model 121 to obtain a highly trusted (completely trusted) pseudo-labeled dataset Pₕ and a partially trusted pseudo-labeled dataset Pᵢ, and i is the index of the partially trusted pseudo-labeled dataset. The highly trusted pseudo-labeled dataset Pₕ or the partially trusted pseudo-labeled dataset Pᵢ can contain one or more pseudo-labeled data, respectively.

In an embodiment, the processor 110 may determine that the unlabeled data in the unlabeled dataset U should be allocated to the highly trusted pseudo-labeled dataset Pₕ or the partially trusted pseudo-labeled dataset Pᵢ according to a confidence threshold. Specifically, the processor 110 may input the unlabeled data to the teacher model 121 to generate a probability vector, and the probability vector may include one or more probabilities corresponding to one or more labels, respectively. The processor 110 may allocate the unlabeled data according to the probability vector and the confidence threshold. The processor 110 may add the unlabeled data to the highly trusted pseudo-labeled dataset Pₕ in response to the maximum probability in the probability vector being greater than the confidence threshold. The processor 110 may add the unlabeled data to the partially trusted pseudo-labeled dataset Pᵢ in response to the maximum probability in the probability vector being less than or equal to the confidence threshold. In the highly trusted pseudo-labeled dataset Pₕ, the labels of pseudo-labeled data are more trusted, so these pseudo-labeled data do not need to be re-checked whether the labels are correct. Relatively speaking, in the partially trusted pseudo-labeled dataset Pᵢ, the labels of pseudo-labeled data are less trusted, so these pseudo-labeled data need to be re-checked whether the labels are correct.

For example, the processor 110 may input the unlabeled data in the unlabeled dataset U into the teacher model 121 to generate a probability vector [p1 p2 p3], the probability p1 corresponds to the first type of label, the probability p2 corresponds to the second type of label, and the probability p3 corresponds to the third label. If the probability p2 is greater than the probability p1 and greater than the probability p3, it means that the teacher model 121 recognizes the unlabeled data as data corresponding to the second type of label. Accordingly, the processor 110 can determine whether the probability p2 (i.e., the maximum probability) is greater than the confidence threshold. If the probability p2 is greater than the confidence threshold, the processor 110 may add the unlabeled data to the highly trusted pseudo-labeled dataset Pₕ. If the probability p2 is less than or equal to the confidence threshold, the processor 110 may add the unlabeled data to the partially trusted pseudo-labeled dataset Pᵢ.

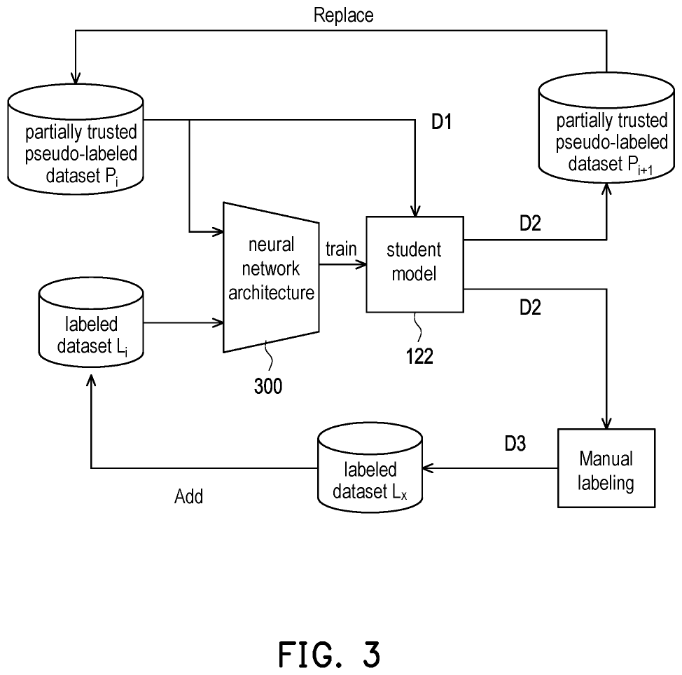

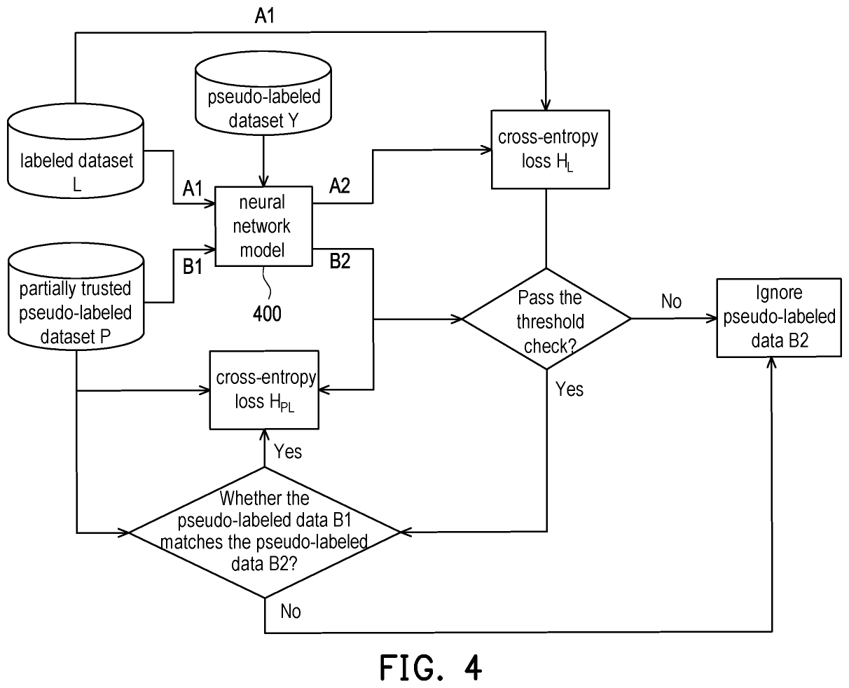

FIG. 3 is a schematic diagram of the second stage of the semi-supervised learning architecture according to an embodiment of the disclosure. The second stage is used to extend the labeled dataset Lᵢ and shrink partially trusted pseudo-labeled dataset Pᵢ. The processor 110 may train the neural network architecture 300 based on the partially trusted pseudo-labeled dataset Pᵢ and the labeled dataset Lᵢ to obtain the student model 122, and the student model 122 may include, but is not limited to, a convolution neural network model. The neural network architecture 300 may include information such as the type of neural network (for example, convolution neural network), the weight configuration method of the neural network, the loss function of the neural network, or the hyperparameters of the neural network, etc. The disclosure is not limited thereto. The neural network architecture 300 can be the same as, partially the same as, or different from the neural network architecture 200. The processor 110 may train the student model 122 according to a pseudo-label adaptive matching training method as shown in FIG. 4.

After completing the training of the student model 122, the processor 110 may input the pseudo-labeled data (or referred to as “third pseudo-labeled data”) D1 in the partially trusted pseudo-labeled dataset Pᵢ to the student model 122 to generate pseudo-labeled data (or referred to as “fourth pseudo-labeled data”) D2. Then, the processor 110 can determine whether the pseudo-labeled data D2 is trusted or not trusted.

If the pseudo-labeled data D2 is trusted, the processor 110 may update the partially trusted pseudo-labeled dataset Pᵢ according to the pseudo-labeled data D2. Specifically, the processor 110 may add the pseudo-labeled data D2 to the partially trusted pseudo-labeled dataset Pᵢ₊₁. After determining whether all pseudo-labeled data in the partially trusted pseudo-labeled dataset Pᵢ is trusted, the processor 110 may obtain the final partially trusted pseudo-labeled dataset Pᵢ₊₁. The processor 110 may use the partially trusted pseudo-labeled dataset Pᵢ₊₁ to replace the partially trusted pseudo-labeled dataset Pᵢ, thereby updating the partially trusted pseudo-labeled dataset Pᵢ.

On the other hand, if the pseudo-labeled data D2 is not trusted, the processor 110 may output the pseudo-labeled data D2 for the user to manually mark the pseudo-labeled data D2, thereby generating the labeled data D3 (or referred to as “fourth labeled data”). The processor 110 may add the labeled data D3 to the labeled dataset Lₓ. After determining whether all the pseudo-labeled data in the partially trusted pseudo-labeled dataset Pᵢ is trusted, the processor 110 may obtain the final labeled dataset Lₓ. The processor 110 may add the labeled data in the final labeled dataset Lₓ to the labeled dataset Lᵢ, so as to update the labeled dataset Lᵢ.

The processor 110 may determine whether the pseudo-labeled data D2 is trusted according to whether the pseudo-labeled data D2 and the pseudo-labeled data D1 are matched. If the pseudo-label of the pseudo-labeled data D2 (or referred to as “fourth pseudo-label”) matches or is the same as the pseudo-label of the pseudo-labeled data D1 (or referred to as “third pseudo-label”), it means that the recognition result of the teacher model 121 is the same as the recognition result of the student model 122. Accordingly, the processor 110 can determine that the pseudo-labeled data D2 is trusted. If the pseudo-label of the pseudo-labeled data D2 does not match or is not the same as the pseudo-label of the pseudo-labeled data D1, it means that the recognition result of the teacher model 121 is different from the recognition result of the student model 122. Accordingly, the processor 110 can determine that the pseudo-labeled data D2 is not trusted.

The processor 110 may repeatedly perform the process shown in FIG. 3 to continuously update the partially trusted pseudo-labeled dataset Pᵢ and the labeled dataset Lᵢ. In each iteration, the labeled dataset Lᵢ will only increase but not decrease, so the labeled dataset Lᵢ will gradually extend with each iteration. After one or more iterations, the processor 110 may obtain the extended labeled dataset Lᵢ, such as the labeled dataset Lⱼ shown in FIG. 6. On the other hand, in each iteration, the partially trusted pseudo-labeled dataset Pᵢ will only decrease but not increase, so the partially trusted pseudo-labeled dataset Pᵢ will gradually shrink with each iteration. After one or more iterations, the processor 110 can obtain a shrunk partially trusted pseudo-labeled dataset Pᵢ, as the partially trusted pseudo-labeled dataset Pⱼ as shown in FIG. 6.

FIG. 4 is a schematic diagram of an adaptive matching training method according to an embodiment of the disclosure. The processor 110 may input the labeled data A1 in the labeled dataset L into the neural network model 400 to obtain the labeled data A2, and the labeled dataset L is, for example, the labeled dataset Lᵢ as shown in FIG. 3 or the labeled dataset Lⱼ as shown in FIG. 6, and the neural network model 400 is, for example, the student model 122 or the final neural network model 123 as shown in FIG. 1. The processor 110 may calculate the cross-entropy loss (or referred to as “second cross-entropy loss”) H_{L} of the labeled data A1 and the labeled data A2.

On the other hand, the processor 110 may input the pseudo-labeled data (or referred to as “first pseudo-labeled data”) B1 in the partially trusted pseudo-labeled dataset P into the neural network model 400 to obtain the pseudo-labeled data (or referred to as “second pseudo-labeled data”) B2, and the partially trusted pseudo-labeled dataset P is, for example, the partially trusted pseudo-labeled dataset Pᵢ as shown in FIG. 3 or the partially trusted pseudo-labeled dataset Pⱼ as shown in FIG. 6.

After obtaining the pseudo-labeled data B2, the processor 110 may perform a threshold check on the pseudo-labeled data B2, and determine whether the pseudo-labeled data B2 passes the threshold check. If the pseudo-labeled data B2 passes the threshold check, the processor 110 may further determine whether the pseudo-labeled data B2 matches the pseudo-labeled data B1. If the pseudo-labeled data B2 fails the threshold check, the processor 110 may ignore the pseudo-labeled data B2, so as not to add the pseudo-labeled data B2 to the pseudo-labeled dataset Y, and the pseudo-labeled dataset Y can be used to train or update the neural network model 400. In other words, the ignored pseudo-labeled data B2 will not be used to train or update the neural network model 400.

Specifically, the pseudo-labeled data B2 may include a probability vector. The processor 110 may perform a threshold check according to the probability vector. In an embodiment, the processor 110 may determine that the pseudo-labeled data B2 passes the threshold check in response to the maximum probability in the probability vector being greater than the probability threshold α. The processor 110 may determine that the pseudo-labeled data B2 fails the threshold check in response to the maximum probability in the probability vector being less than or equal to the probability threshold α. For example, the pseudo-labeled data B2 may include a probability vector [p11 p12 p13], and the probability p11 corresponds to the first type of label, the probability p12 corresponds to the second type of label, and the probability p13 corresponds to the third type of label. If the probability p12 is greater than the probability p11 and greater than the probability p13, the processor 110 may determine whether the probability p12 (i.e., the maximum probability) is greater than the probability threshold α. If the probability p12 is greater than the probability threshold α, the processor 110 may determine that the pseudo-labeled data B2 passes the threshold check. If the probability p12 is less than or equal to the probability threshold α, the processor 110 may determine that the pseudo-labeled data B2 fails the threshold check.

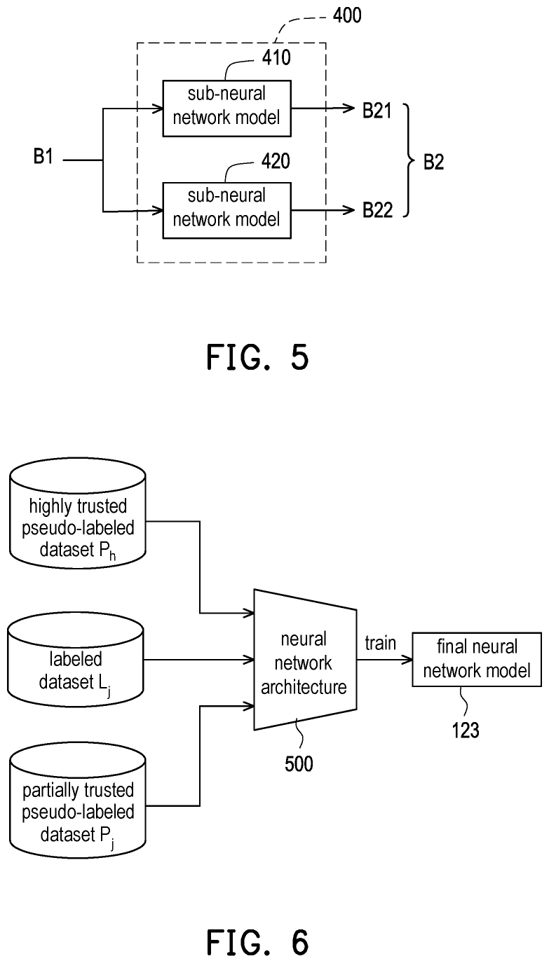

The neural network model 400 may include one or more sub-neural network models. FIG. 5 is a schematic diagram of sub-neural network models 410 and 420 according to an embodiment of the disclosure. It is assumed that the neural network model 400 may include a sub-neural network model 410 and a sub-neural network model 420. The processor 110 may input the pseudo-labeled data B1 to the neural network model 400 to generate the pseudo-labeled data B2, and the pseudo-labeled data B2 may include the pseudo-labeled data B21 output by the sub-neural network model 410 and the pseudo-labeled data B22 output by the sub-neural network model 420. The pseudo-labeled data B21 may include the first probability vector and the first sub-pseudo-label. The pseudo-labeled data B22 may include the second probability vector and the second sub-pseudo-label. In other words, the pseudo-label of the pseudo-labeled data B2 may include a first sub-pseudo-label corresponding to the pseudo-labeled data B21 and a second sub-pseudo-label corresponding to the pseudo-labeled data B22.

In an embodiment, the processor 110 may calculate the average probability of the first maximum probability in the first probability vector of the pseudo-labeled data B21 and the second maximum probability in the second probability vector of the pseudo-labeled data B22. If the average probability is greater than the probability threshold α, the processor 110 may determine that the pseudo-labeled data B2 passes the threshold check. If the average probability is less than or equal to the probability threshold α, the processor 110 may determine that the pseudo-labeled data B2 fails the threshold check. For example, suppose that pseudo-labeled data B21 can include a first probability vector [p21 p22 p23], and the pseudo-labeled data B22 can include a second probability vector [p31 p32 p33], the probability p22 is greater than the probability p21 and greater than the probability p23, and the probability p32 is greater than the probability p31 and greater than the probability p33. The processor 110 can calculate the average of the probability p22 and the probability p32. If the average of the probability p22 and the probability p32 is greater than the probability threshold α, the processor 110 may determine that the pseudo-labeled data B2 passes the threshold check. If the average of the probability p22 and the probability p32 is less than or equal to the probability threshold α, the processor 110 may determine that the pseudo-labeled data B2 fails the threshold check.

In an embodiment, the processor 110 may determine that the pseudo-labeled data B2 passes the threshold check in response to the first maximum probability in the first probability vector of the pseudo-labeled data B21 being greater than the probability threshold α and the second maximum probability in the second probability vector of the pseudo-labeled data B22 being greater than the probability threshold α. The processor 110 may determine that the pseudo-labeled data B2 fails the threshold check in response to at least one of the first maximum probability or the second maximum probability being less than or equal to the probability threshold α. For example, suppose that the pseudo-labeled data B21 can include a first probability vector [p21 p22 p23], and the pseudo-labeled data B22 can include a second probability vector [p31 p32 p33], the probability p22 is greater than the probability p21 and greater than the probability p23, and the probability p32 is greater than the probability p31 and greater than the probability p33. The processor 110 may determine that the pseudo-labeled data B2 passes the threshold check in response to the probability p22 and the probability p32 both being greater than the probability threshold α. The processor 110 may determine that the pseudo-labeled data B2 fails the threshold check in response to at least one of the probability p22 or the probability p32 being less than or equal to the probability threshold α.

Back to FIG. 4, after the pseudo-labeled data B2 passes the threshold check, the processor 110 can determine whether the pseudo-label (or referred to as “second pseudo-label”) of the pseudo-labeled data B2 matches the pseudo-label (or referred to as “first pseudo-label”) of the pseudo-labeled data B1. If the pseudo-label of the pseudo-labeled data B2 matches the pseudo-label of the pseudo-labeled data B1, the processor 110 may calculate the cross-entropy loss (or referred to as “first cross-entropy loss”) H_{PL} between the pseudo-labeled data B1 and the pseudo-labeled data B2, and may add the pseudo-labeled data B2 to the pseudo-labeled dataset Y. If the pseudo-label of the pseudo-labeled data B2 does not match the pseudo-label of the pseudo-labeled data B1, the processor 110 may ignore the pseudo-labeled data B2, and does not add the pseudo-labeled data B2 to the pseudo-labeled dataset Y.

Referring to FIG. 4 and FIG. 5, suppose that the pseudo-labeled data B2 includes the pseudo-labeled data B21 and the pseudo-labeled data B22. The pseudo-labeled data B21 may include the first probability vector and the first sub-pseudo-label. The pseudo-labeled data B22 may include the second probability vector and the second sub-pseudo-label. In an embodiment, the processor 110 may calculate the average probability vector of the first probability vector and the second probability vector, and determine the pseudo-label of the pseudo-labeled data B2 according to the average probability vector. For example, if the maximum probability in the average probability vector corresponds to the second type of label, the processor 110 may determine that the pseudo-label of the pseudo-labeled data B2 is the second type of label. In an embodiment, the processor 110 may determine that the pseudo-label of the pseudo-labeled data B2 matches the pseudo-label of the pseudo-labeled data B1 in response to that the first sub-pseudo-label of the pseudo-labeled data B21 matches the pseudo-labeled data B1 and the second sub-pseudo-label of the pseudo-labeled data B22 matches the pseudo-labeled data B1.

After obtaining the cross-entropy loss H_{PL} and the cross-entropy loss H_{L}, the processor 110 may obtain a loss function LF as shown in equation (1), and β is the loss weight. The processor 110 can train or update the neural network model 400 according to the loss function LF and the pseudo-labeled dataset Y. The processor 110 may repeatedly perform the process shown in FIG. 4 until the performance of the neural network model 400 meets the needs of the user. It should be noted that, every time before executing the process shown in FIG. 4, the processor 110 may first reset the pseudo-labeled dataset Y to an empty set.

LF=H_{L}+βH_{PL} (1)

FIG. 6 is a schematic diagram of the third stage of the semi-supervised learning architecture according to an embodiment of the disclosure. After repeatedly updating the labeled dataset Lᵢ and the partially trusted pseudo-labeled dataset Pᵢ, the processor 110 can obtain the labeled dataset Lⱼ and the partially trusted pseudo-labeled dataset Pⱼ. The processor 110 may train the final neural network model 123 based on the neural network architecture 300 according to the trusted pseudo-labeled dataset Pₕ, the labeled dataset Lⱼ, and the partially trusted pseudo-labeled dataset Pⱼ, and the final neural network model 123 may include, but is not limited to, convolution neural network model. The neural network architecture 500 may include information such as the type of neural network (for example, convolution neural network), the weight configuration method of the neural network, the loss function of the neural network, or the initial hyperparameters of the neural network. This disclosure is not limited thereto. The neural network architecture 500 may be the same as, partially the same as, or different from the neural network architecture 200 (or 300).

In an embodiment, the processor 110 may train the final neural network model 123 according to supervised learning. In an embodiment, the processor 110 may train the final neural network model 123 according to the adaptive matching training method shown in FIG. 4.

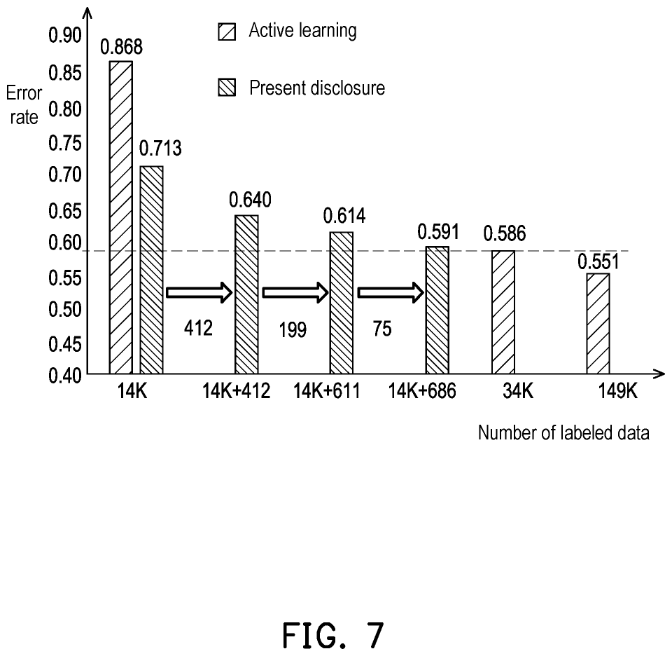

FIG. 7 is a schematic diagram of the test results of the present disclosure (i.e., semi-supervised learning based on adaptive matching of pseudo-label) and the conventional active learning method according to an embodiment of the disclosure. The dataset adopted in this experiment is AOI-1 labeled dataset. When 14,000 labeled data are input, the error rate of the model generated by active learning is 0.868, and the error rate of the model generated by this disclosure is 0.713. To achieve an error rate of 0.586, at least 34,000 labeled data is required for active learning. To further reduce the error rate to 0.551, at least 149,000 labeled data is required for active learning. In other words, if the user wants to use the conventional active learning method to train the model, a lot of manpower is required to generate labeled data to improve the performance of the model.

On the other hand, when the second iteration of the process shown in FIG. 3 is executed, the present disclosure only needs to add 412 labeled data to reduce the error rate of the model to 0.640. When the third iteration of the process shown in FIG. 3 is executed, the present disclosure only needs to add 199 labeled data to reduce the error rate of the model to 0.614. When the fourth iteration of the process shown in FIG. 3 is executed, the present disclosure only needs to add 75 labeled data to reduce the error rate of the model to 0.591. In other words, the disclosure only needs to add a small amount of labeled data to significantly improve the performance of the model. Therefore, the disclosure can greatly reduce the labor and time for generating labeled data.

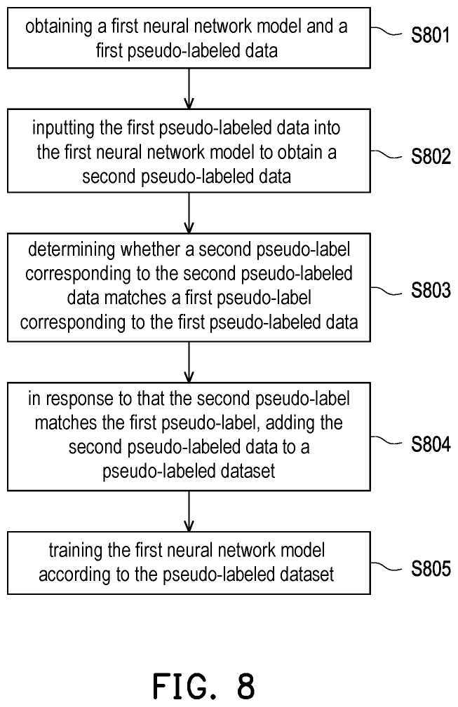

FIG. 8 is a flowchart of a method adaptable for training a neural network model according to an embodiment of the disclosure, and the method can be implemented by the electronic device 100 shown in FIG. 1. In step S801, the first neural network model and the first pseudo-labeled data are obtained. In step S802, the first pseudo-labeled data is input to the first neural network model to obtain the second pseudo-labeled data. In step S803, it is determined whether the second pseudo-label corresponding to the second pseudo-labeled data matches the first pseudo-label corresponding to the first pseudo-labeled data. In step S804, in response to the second pseudo-label matching the first pseudo-label, the second pseudo-labeled data is added to the pseudo-labeled dataset. In step S805, the first neural network model is trained according to the pseudo-labeled dataset.

In summary, the electronic device disclosed in the present disclosure can train a teacher model according to a small amount of manually generated labeled data based on a supervised learning algorithm, and then use the teacher model to mark a large amount of unlabeled data to generate pseudo-labeled data. The electronic device can train or update the student model according to the artificial labeled data and pseudo-labeled data based on the adaptive matching algorithm, so as to improve the student model's ability to recognize pseudo-labeled data. The electronic device can use the student model to determine whether the pseudo-label of the pseudo-labeled data is trusted. If the pseudo-label is not trusted, the electronic device can instruct the user to manually determine the correct label of the pseudo-labeled data. In short, the electronic device can select a small amount of pseudo-labeled data that needs to be manually checked from multiple pseudo-labeled data, and the pseudo-labels of other pseudo-labeled data can be regarded as correct labels. The user can train a neural network model with high performance based on the pseudo-labeled dataset generated by the method in the disclosure.

What is claimed is:

1. An electronic device adaptable for training a neural network model, comprising:
a storage medium, storing a first neural network model; and
a processor, coupled to the storage medium, wherein the processor is configured to:
obtain a first pseudo-labeled data;
input the first pseudo-labeled data into the first neural network model to obtain a second pseudo-labeled data;
determine whether a second pseudo-label corresponding to the second pseudo-labeled data matches a first pseudo-label corresponding to the first pseudo-labeled data;
in response to that the second pseudo-label matches the first pseudo-label, add the second pseudo-labeled data to a pseudo-labeled dataset; and
train the first neural network model according to the pseudo-labeled dataset.

2. The electronic device according to claim 1, wherein the second pseudo-labeled data comprises a probability vector, and the processor is further configured to:
in response to a maximum probability in the probability vector being greater than a probability threshold, determine whether the second pseudo-label matches the first pseudo-label.

3. The electronic device according to claim 1, wherein the processor is further configured to:
in response to the second pseudo-label matching the first pseudo-label, calculate a first cross-entropy loss between the first pseudo-labeled data and the second pseudo-labeled data; and
train the first neural network model according to a loss function associated with the first cross-entropy loss.

4. The electronic device according to claim 3, wherein the processor is further configured to:
obtain a first labeled data;
input the first labeled data to the first neural network model to obtain a second labeled data;
calculate a second cross-entropy loss between the first labeled data and the second labeled data; and
train the first neural network model according to the loss function associated with the second cross-entropy loss.

5. The electronic device according to claim 1, wherein the first neural network model comprises a first sub-neural network model and a second sub-neural network model, and the second pseudo-labeled data comprises a first probability vector corresponding to the first sub-neural network model and a second probability vector corresponding to the second sub-neural network model, wherein the processor is further configured to:
calculate an average probability of a first maximum probability in the first probability vector and a second maximum probability in the second probability vector; and
in response to the average probability being greater than a probability threshold, determine whether the second pseudo-label matches the first pseudo-label.

6. The electronic device according to claim 1, wherein the first neural network model comprises a first sub-neural network model and a second sub-neural network model, and the second pseudo-labeled data comprises a first probability vector corresponding to the first sub-neural network model and a second probability vector corresponding to the second sub-neural network model, wherein the processor is further configured to:
in response to a first maximum probability in the first probability vector being greater than a probability threshold and a second maximum probability in the second probability vector being greater than the probability threshold, determine whether the second pseudo-label matches the first pseudo-label.

7. The electronic device according to claim 1, wherein the first neural network model comprises a first sub-neural network model and a second sub-neural network model, and the second pseudo-labeled data comprises a first probability vector corresponding to the first sub-neural network model and a second probability vector corresponding to the second sub-neural network model, wherein the processor is further configured to:
calculate an average probability vector of the first probability vector and the second probability vector; and
determine the second pseudo-label according to the average probability vector.

8. The electronic device according to claim 1, wherein the first neural network model comprises a first sub-neural network model and a second sub-neural network model, and the second pseudo-label comprises a first sub-pseudo-label corresponding to the first sub-neural network model and a second sub-pseudo-label corresponding to the second sub-neural network model, wherein the processor is further configured to:
in response to the first sub-pseudo-label matching the first pseudo-label and the second sub-pseudo-label matching the first pseudo-label, determine that the second pseudo-label matches the first pseudo-label.

9. The electronic device according to claim 1, wherein the processor is further configured to:
train a second neural network model according to a labeled dataset;
input an unlabeled dataset into the second neural network model to obtain a highly trusted pseudo-labeled dataset and a partially trusted pseudo-labeled dataset; and
train the first neural network model according to the partially trusted pseudo-labeled dataset, wherein the partially trusted pseudo-labeled dataset comprises the first pseudo-labeled data.

10. The electronic device according to claim 9, wherein the processor is further configured to:
train a final neural network model according to the labeled dataset, the highly trusted pseudo-labeled dataset, and the partially trusted pseudo-labeled dataset.

11. The electronic device according to claim 10, wherein the processor is further configured to:
input a third pseudo-labeled data in the partially trusted pseudo-labeled dataset into the first neural network model to obtain a fourth pseudo-labeled data; and
in response to a fourth pseudo-label of the fourth pseudo-labeled data matching a third pseudo-label of the third pseudo-labeled data, update the partially trusted pseudo-labeled dataset according to the fourth pseudo-labeled data.

12. The electronic device according to claim 10, wherein the processor is further configured to:
input a third pseudo-labeled data in the partially trusted pseudo-labeled dataset into the first neural network model to obtain a fourth pseudo-labeled data;
in response to a fourth pseudo-label of the fourth pseudo-labeled data not matching a third pseudo-label of the third pseudo-labeled data, output the fourth pseudo-labeled data and receive a fourth labeled data corresponding to the fourth pseudo-labeled data; and
update the labeled dataset according to the fourth labeled data.

13. A method adaptable for training a neural network model, comprising:
obtaining a first neural network model and a first pseudo-labeled data;
inputting the first pseudo-labeled data into the first neural network model to obtain a second pseudo-labeled data;
determining whether a second pseudo-label corresponding to the second pseudo-labeled data matches a first pseudo-label corresponding to the first pseudo-labeled data;
in response to that the second pseudo-label matches the first pseudo-label, adding the second pseudo-labeled data to a pseudo-labeled dataset; and
training the first neural network model according to the pseudo-labeled dataset.

14. The method according to claim 13, wherein the second pseudo-labeled data comprises a probability vector, and the step of determining whether the second pseudo-label corresponding to the second pseudo-labeled data matches the first pseudo-labeled data corresponding to the first pseudo-labeled data comprises:
in response to a maximum probability in the probability vector being greater than a probability threshold, determining whether the second pseudo-label matches the first pseudo-label.

15. The method according to claim 13, wherein the step of training the first neural network model according to the pseudo-labeled dataset comprises:
in response to the second pseudo-label matching the first pseudo-label, calculating a first cross-entropy loss between the first pseudo-labeled data and the second pseudo-labeled data; and
training the first neural network model according to a loss function associated with the first cross-entropy loss.

16. The method according to claim 15, wherein the step of training the first neural network model according to the pseudo-labeled dataset further comprises:
obtaining a first labeled data;
inputting the first labeled data to the first neural network model to obtain a second labeled data;
calculating a second cross-entropy loss between the first labeled data and the second labeled data; and
training the first neural network model according to the loss function associated with the second cross-entropy loss.

17. The method according to claim 13, wherein the first neural network model comprises a first sub-neural network model and a second sub-neural network model, and the second pseudo-labeled data comprises a first probability vector corresponding to the first sub-neural network model and a second probability vector corresponding to the second sub-neural network model, wherein the step of determining whether the second pseudo-label corresponding to the second pseudo-labeled data matches the first pseudo-label corresponding to the first pseudo-labeled data comprises:
calculating an average probability of a first maximum probability in the first probability vector and a second maximum probability in the second probability vector; and
in response to the average probability being greater than a probability threshold, determining whether the second pseudo-label matches the first pseudo-label.

18. The method according to claim 13, wherein the first neural network model comprises a first sub-neural network model and a second sub-neural network model, and the second pseudo-labeled data comprises a first probability vector corresponding to the first sub-neural network model and a second probability vector corresponding to the second sub-neural network model, wherein the step of determining whether the second pseudo-label corresponding to the second pseudo-labeled data matches the first pseudo-label corresponding to the first pseudo-labeled data comprises:
in response to a first maximum probability in the first probability vector being greater than a probability threshold and a second maximum probability in the second probability vector being greater than the probability threshold, determining whether the second pseudo-label matches the first pseudo-label.

19. The method according to claim 13, wherein the first neural network model comprises a first sub-neural network model and a second sub-neural network model, and the second pseudo-labeled data comprises a first probability vector corresponding to the first sub-neural network model and a second probability vector corresponding to the second sub-neural network model, wherein the step of determining whether the second pseudo-label corresponding to the second pseudo-labeled data matches the first pseudo-label corresponding to the first pseudo-labeled data comprises:
calculating an average probability vector of the first probability vector and the second probability vector; and
determining the second pseudo-label according to the average probability vector.

20. The method according to claim 13, wherein the first neural network model comprises a first sub-neural network model and a second sub-neural network model, and the second pseudo-label comprises a first sub-pseudo-label corresponding to the first sub-neural network model and a second sub-pseudo-label corresponding to the second sub-neural network model, wherein the step of determining whether the second pseudo-label corresponding to the second pseudo-labeled data matches the first pseudo-label corresponding to the first pseudo-labeled data comprises:
in response to the first sub-pseudo-label matching the first pseudo-label and the second sub-pseudo-label matching the first pseudo-label, determining that the second pseudo-label matches the first pseudo-label.

21. The method according to claim 13, further comprising:
training a second neural network model according to a labeled dataset;
inputting an unlabeled dataset into the second neural network model to obtain a highly trusted pseudo-labeled dataset and a partially trusted pseudo-labeled dataset; and
training the first neural network model according to the partially trusted pseudo-labeled dataset, wherein the partially trusted pseudo-labeled dataset comprises the first pseudo-labeled data.

22. The method according to claim 21, further comprising:
training a final neural network model according to the labeled dataset, the highly trusted pseudo-labeled dataset, and the partially trusted pseudo-labeled dataset.

23. The method according to claim 22, further comprising:
inputting a third pseudo-labeled data in the partially trusted pseudo-labeled dataset into the first neural network model to obtain a fourth pseudo-labeled data; and
in response to a fourth pseudo-label of the fourth pseudo-labeled data matching a third pseudo-label of the third pseudo-labeled data, updating the partially trusted pseudo-labeled dataset according to the fourth pseudo-labeled data.

24. The method according to claim 22, further comprising:
inputting a third pseudo-labeled data in the partially trusted pseudo-labeled dataset into the first neural network model to obtain a fourth pseudo-labeled data;
in response to a fourth pseudo-label of the fourth pseudo-labeled data not matching a third pseudo-label of the third pseudo-labeled data, outputting the fourth pseudo-labeled data and receiving a fourth labeled data corresponding to the fourth pseudo-labeled data; and
updating the labeled dataset according to the fourth labeled data.
